(19) United States
(12) Patent Application Publication
(10) Pub. No.: US 2008/0074548 A1
(43) Pub. Date: Mar. 27, 2008

(54) Television image capturing system

(76) Inventors: Hideki Nagata, Hachioji-shi (JP); Minoru Omaki, Kunitachi-shi (JP); Nobuyuki Watanabe, Yokohama-shi (JP)

Correspondence Address: KENYON & KENYON LLP, ONE BROADWAY, NEW YORK, NY, 10004, US

(21) Appl. No.: 11/901,885

(22) Filed: Sep. 18, 2007

(30) Foreign Application Priority Data
Sep. 25, 2006 (JP) 2006-258497

(51) Int. Cl. H04N 5/44

(52) U.S. Cl. 348/559

(57) ABSTRACT

A desired television image at a desired moment can be stored in a portable terminal while viewing a video image on a television set, without carrying out a complicated operation. A television image capturing system is provided, the system including a television set and a portable terminal, each having a tuner that is capable of receiving a television signal and a monitor, wherein the portable terminal includes a tuner synchronization unit for synchronizing the tuner of the portable terminal with the tuner of the television set, a capture switch for generating a trigger signal, a storage unit for storing image information, and a control unit for storing the image information received by the tuner in the storage unit in response to the trigger signal generated by the capture switch.

### BACKGROUND OF THE INVENTION

1. Field of the Invention

The present invention relates to a television image capturing system.

This application is based on Japanese Patent Application No. 2006-258497, the content of which is incorporated herein by reference.

2. Description of Related Art

There are known television sets in the related art that store, in a memory, images received by a tuner of the television set in response to a trigger signal from a remote controller (for example, see Japanese Unexamined Patent Application, Publication No. 2002-199323).

However, when a user wants to store and carry around image information stored in the memory of a television set in a portable terminal, such as a mobile phone, the image information must be temporarily stored in a storage medium, such as a USB memory or a CD-ROM, and then transferred to the mobile phone, or the television set and the mobile phone must be connected via a cable to transfer the image data. This is disadvantageous in that a complicated operation must be carried out.

### BRIEF SUMMARY OF THE INVENTION

A first aspect provides a television image capturing system including a television set and a portable terminal, each having a tuner that is capable of receiving a television signal and a monitor, wherein the portable terminal includes a tuner synchronization unit for synchronizing the tuner of the portable terminal with the tuner of the television set, a capture switch for generating a trigger signal, a storage unit for storing image information, and a control unit for storing the image information received by the tuner in the storage unit in response to the trigger signal generated by the capture switch.

A second aspect provides a television image capturing system that is the same as that according to the first aspect, except that the television set includes a reception-information transmission unit for transmitting reception information of the tuner, the portable terminal includes a reception-information reception unit for receiving reception information transmitted from the television set, and the tuner synchronization unit synchronizes the tuner of the portable terminal with the tuner of the television set on the basis of the received reception information.

A third aspect provides a television image capturing system that is the same as that according to the second aspect, except that the reception-information transmission unit transmits reception information of the tuner by short-range wireless communication.

A fourth aspect provides a television image capturing system that is the same as that according to the second aspect, except that the television set includes an identification-information transmission unit for transmitting identification information of the television set by short-range wireless communication, the portable terminal includes an identification-information reception unit for receiving the identification information from the television set and a reception-information requesting unit for requesting the television set having identification information received by the identification-information reception unit to transmit the reception information of the tuner, and the reception-information transmission unit transmits the reception information of the tuner in response to the request transmitted from the reception-information requesting unit.

### BRIEF DESCRIPTION OF THE SEVERAL VIEWS OF THE DRAWINGS

FIG. 1 is a block diagram illustrating a television image capturing system.

FIG. 2 is a block diagram illustrating a modification of the television image capturing system.

### DETAILED DESCRIPTION OF THE INVENTION

A television image capturing system according to the present invention includes a television set and a portable terminal, each having a tuner that is capable of receiving a television signal and a monitor. The portable terminal includes a tuner synchronization unit for synchronizing the tuner of the portable terminal with the tuner of the television set, a capture switch for generating a trigger signal, a storage unit for storing image information, and a control unit for storing the image information received by the tuner in the storage unit in response to the trigger signal generated by the capture switch.

According to this television image capturing system, merely by pushing the capture switch of the portable terminal when a desired video image is displayed on the monitor of the television set while viewing a video image received by the tuner, the image information received at that moment by the tuner of the television set is stored in the storage unit of the portable terminal.

In other words, by operating the tuner synchronization unit, the tuner of the portable terminal is synchronized with the tuner of the television set, and the same video image received by the tuner of the television set is also received by the tuner of the portable terminal. As the tuner synchronization unit, a unit that carries out synchronization based on frequency or based on sound may be employed.

In this state, when the capture switch of the portable terminal is pushed, a trigger signal is generated and the control unit stores the image information received at that moment by the tuner of the portable terminal in the storage unit.

In this way, image information received by the television set can be stored in the portable terminal and carried around without performing a complicated operation.

In the above-described television image capturing system, the television set may include a reception-information transmission unit for transmitting reception information of the tuner, the portable terminal may include a reception-information reception unit for receiving reception information transmitted from the television set, and the tuner synchronization unit may synchronize the tuner of the portable terminal with the tuner of the television set on the basis of the received reception information.

In this way, since the television set sends reception information to an external unit by operating the reception-information transmission unit, when the portable terminal moves into a range in which the reception information can be received, the reception information sent from the television set is received by operating the reception-information transmission unit of the portable terminal. When the reception information is received, the tuner of the portable terminal is synchronized with the tuner of the television set by operating the tuner synchronization unit, and the same video image received by the tuner of the television set is also received by the tuner of the portable terminal.

In this state, when the capture switch of the portable terminal is pushed, a trigger signal is generated and the control unit stores the image information received at that moment by the tuner of the portable terminal in the storage unit. In this way, image information received by a television set can be stored in the portable terminal and carried around without performing complicated operation.

In the above-described television image capturing system, the reception-information transmission unit may transmit reception information of the tuner by short-range wireless communication. With short-range wireless communication, the transmission range of reception information is limited to a predetermined range: for example, 10 m or less. Therefore, the tuner of a portable terminal owned by a person viewing the monitor of the television set can be automatically synchronized with the tuner of the television set. On the other hand, synchronization of a tuner of a portable terminal owned by a person far away from the television set, who is less likely to be viewing the monitor of the television set, is not carried out.

In the above-described television image capturing system, the television set may include an identification-information transmission unit for transmitting identification information of the television set by short-range wireless communication, the portable terminal may include an identification-information reception unit for receiving the identification information from the television set and a reception-information requesting unit for requesting the television set having the identification information received by the identification-information reception unit to transmit the reception information of the tuner, and the reception-information transmission unit may transmit the reception information of the tuner in response to the request transmitted from the reception-information requesting unit.

In this way, when identification information sent from the identification-information transmission unit of the television set is received by the identification-information reception unit of the portable terminal, it can be determined that the portable terminal is disposed within a close range of the television set. Therefore, when such determination is made, the reception-information requesting unit of the portable terminal is operated to request the television set to send reception information of the tuner, and the reception-information transmission unit of the television set sends the reception information of the tuner in response to the request. In this way, in the portable terminal, the identification information of the television set is compared, and only when the identification information matches, the tuner of the portable terminal is synchronized with the tuner of the television set.

The above-described television image capturing system is advantageous in that when a video image that the user desires to store in a portable terminal and carry around is displayed while viewing video images on a television set, the television image can be stored in the portable terminal at a desired moment without performing a complicated operation.

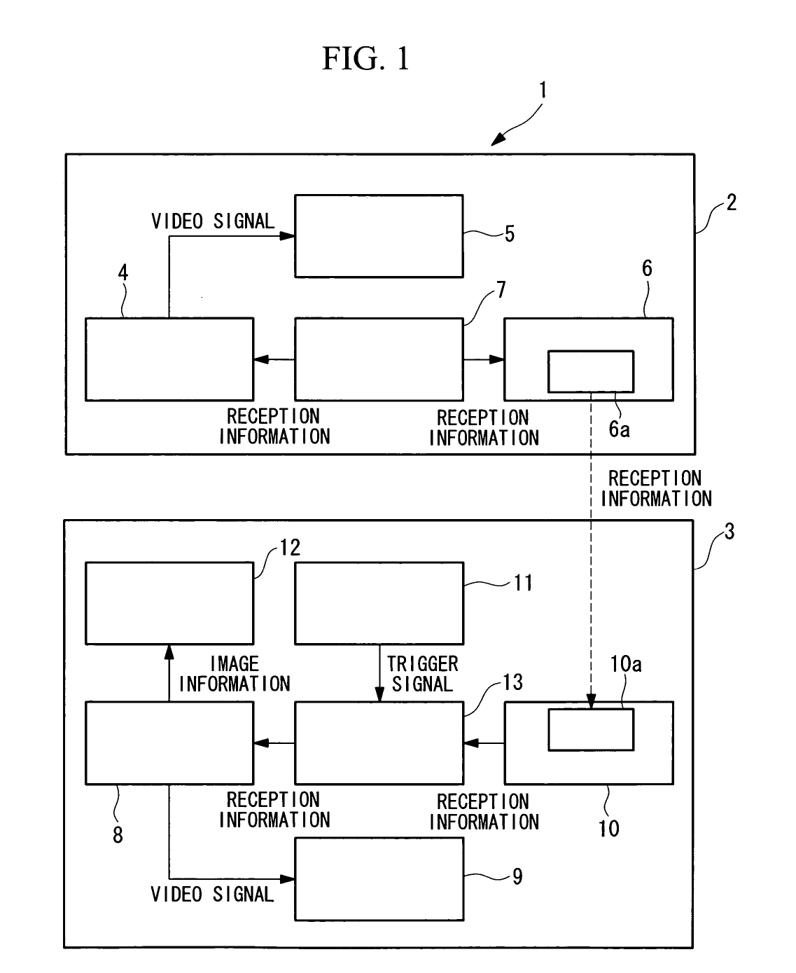

A television image capturing system 1 will be described with reference to FIG. 1.

As shown in FIG. 1, the television image capturing system 1 includes a television set 2 and a portable terminal 3. The portable terminal 3 is, for example, a mobile phone.

The television set 2 includes a tuner 4 for receiving broadcasted video signals, a monitor 5 for displaying video images received by the tuner 4, a communication device 6 for communicating with an external unit, and a control device 7 for controlling the communication device 6 and the tuner 4.

The tuner 4 extracts and receives, from broadcasted video signals, video signals matching reception information instructed by the control device 7, such as information about the current station being received (for example, the frequency or channel), and outputs these to the monitor 5.

The communication device 6 includes a transmission unit (reception-information transmitting unit) 6a that transmits reception information of the tuner 4. The transmission unit 6a uses, for example, short-range wireless communication, such as infrared communication or a wireless tag, and has a communication range of about 10 m.

The control device 7 instructs reception information to the tuner 4 and instructs the transmission unit 6a of the communication device 6 to send the reception information from the transmission unit 6a to an external unit.

The portable terminal 3 includes a tuner 8 for receiving broadcasted video signals, a monitor 9 for displaying video images received by the tuner 8, a communication device 10 for communicating with an external unit, a capture switch 11 that generates a trigger signal for saving image information, a storage device (storage unit) 12 for storing image information, and a control device (control unit) 13 for controlling the units.

The communication device 10 includes a reception unit (reception-information receiving unit) 10a for receiving reception information of the tuner 4 in the television set 2 sent from the communication device 6 included in the television set 2 while the portable terminal 3 is within a 10-meter-radius range centered around the television set 2.

When reception information from the television set 2 is received by the reception unit 10a of the communication device 10, the control device 13 sends the received reception information to the tuner 8 of the portable terminal 3 in order to synchronize the tuner 8 with the tuner 4 of the television set 2. The control device 13 receives the trigger signal output when the capture switch 11 is pushed, and, at that moment, saves the image information received by the tuner 8 of the portable terminal 3 and stores it in the storage device 12.

Sound generated at a speaker of the television set 2 by the control device 13 may be collected with a microphone included in the portable terminal 3, and, for example, frequency analysis may be carried out on the collected sound of the television set 2 so as to synchronize the tuner 8 of the portable terminal 3 with the tuner 4 of the television set 2 on the basis of the analysis result.

The operation of the television image capturing system 1 having such a structure will now be described.

According to the television image capturing system 1, when the television set 2 is operated and a video image received by the tuner 4 is displayed on the monitor 5, reception information of the tuner 4 is sent from the transmission unit 6a of the television set 2 to an external unit by short-range wireless communication. Then, when the portable terminal 3 enters the communication range of the short-range wireless communication, the reception information sent from the transmission unit 6a of the television set 2 is received by the reception unit 10a of the portable terminal 3.

When the reception information is received by the reception unit 10a, the operation of the control device 13 causes the reception information to be sent to the tuner 8 of the portable terminal 3, and the tuner 8 of the portable terminal 3 is set to the same reception state as the tuner 4 of the television set 2. In this way, the video information displayed on the monitor 5 of the television set 2 can also be received by the tuner 8 of the portable terminal 3.

In this state, if the capture switch 11 of the portable terminal is operated, a trigger signal is generated. Thus, on the basis of the trigger signal, the control device 13 saves the image information in which the video information at that instant is cut out and stores it in the storage device 12.

In this way, when a viewer viewing a video image on the monitor 5 of the television set 2 pushes the capture switch 11 of the portable terminal 3 at a desired display point of the video image, the desired video image can be stored in the storage device of the portable terminal 3. Therefore, the desired image information of the television set 2 can be stored and carried around in the portable terminal 3 by merely pushing the capture switch 11, without performing a complicated operation, such as storing image information in the television set 2 and transferring the stored image information by using a storage medium or via communication.

In the television image capturing system 1, the tuner 4 of the television set 2 and the tuner 8 of the portable terminal 3 are synchronized by detecting reception information sent by short-range wireless communication in the portable terminal 3.

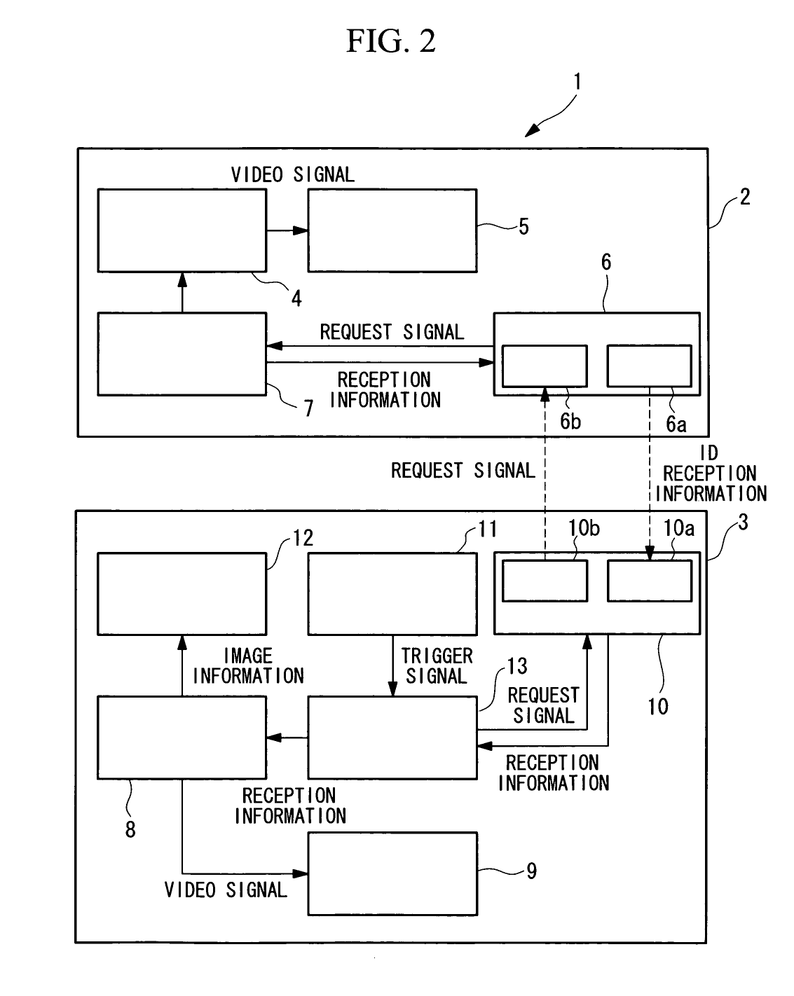

Instead, however, as shown in FIG. 2, the communication device 6 of the television set 2 may include a reception unit 6b for receiving a request signal, and the transmission unit (identification-information transmission unit/reception-information transmission unit) 6a of the television set 2 may send identification information (ID) by short-range wireless communication, receive a request from the portable terminal 3, and send the reception information of the tuner 4. In such a case, it is preferable to include a transmission unit (request-signal transmission unit) 10b for sending a request signal for requesting the transmission of the reception information of the tuner 4 in the television set 2 when the communication device 10 of the portable terminal 3 receives the identification information from the television set 2.

In this way, the control device 13 of the portable terminal 3 can compare the identification information registered in advance and the received identification information of the television set 2 and can request the transmission of the reception information only when they match.

In this embodiment, a mobile phone is described as an example of the portable terminal 3. However, the portable terminal 3 is not limited thereto, and any type of portable terminal 3, such as a PDA or a personal computer, may be employed.

The portable terminal 3 may be provided with a cancellation switch (not shown) for canceling the synchronization of the tuner 8 with the tuner 4 of the television set 2 in the vicinity of the television set 2.

What is claimed is:

1. A television image capturing system comprising:
a television set and a portable terminal, each having a tuner that is capable of receiving a television signal and a monitor,
wherein the portable terminal includes a tuner synchronization unit for synchronizing the tuner of the portable terminal with the tuner of the television set, a capture switch for generating a trigger signal, a storage unit for storing image information, and a control unit for storing the image information received by the tuner in the storage unit in response to the trigger signal generated by the capture switch.

2. The television image capturing system according to claim 1,
wherein the television set includes a reception-information transmission unit for transmitting reception information of the tuner,
wherein the portable terminal includes a reception-information reception unit for receiving reception information transmitted from the television set, and
wherein the tuner synchronization unit synchronizes the tuner of the portable terminal with the tuner of the television set on the basis of the received reception information.

3. The television image capturing system according to claim 2, wherein the reception-information transmission unit transmits reception information of the tuner by short-range wireless communication.

4. The television image capturing system according to claim 2,
wherein the television set includes an identification-information transmission unit for transmitting identification information of the television set by short-range wireless communication,
wherein the portable terminal includes an identification-information reception unit for receiving the identification information from the television set and a reception-information requesting unit for requesting the television set having the identification information received by the identification-information reception unit transmit the reception information of the tuner, and
wherein the reception-information transmission unit transmits the reception information of the tuner in response to the request transmitted from the reception-information requesting unit.
